(19) United States
(12) Patent Application Publication
(10) Pub. No.: US 2016/0008926 A1
(43) Pub. Date: Jan. 14, 2016

(54) METHOD OF COLD-CLEAVING SAPPHIRE MATERIAL AT CRYOGENIC TEMPERATURES

(71) Applicant: Rubicon Technology, Inc., Bensenville, IL (US)

(72) Inventor: John P. CIRALDO, Elgin, IL (US)

(73) Assignee: RUBICON TECHNOLOGY, INC., Bensenville, IL (US)

(21) Appl. No.: 14/794,401

(22) Filed: Jul. 8, 2015

Related U.S. Application Data
(60) Provisional application No. 62/024,249, filed on Jul. 14, 2014.

(51) Int. Cl. B23K 26/70; B23K 26/38; B23K 26/035; B26F 3/00; B23K 26/00

(52) U.S. Cl. CPC B23K 26/703; B26F 3/002; B23K 26/0006; B23K 26/035; B23K 26/38; B23K 2203/50

(57) ABSTRACT

A process for cold cleaving a single-crystal material such as sapphire at cryogenic temperatures includes cooling the single-crystal material to a cryogenic temperature such as, e.g., about the boiling point of nitrogen. The cooled single-crystal material may then be cleaved or divided along a plane of the single-crystal material producing sharp edged portions.

This application claims benefit and priority to U.S. Provisional Application Ser. No. 62/024,249 entitled METHOD OF COLD-CLEAVING SAPPHIRE MATERIAL AT CRYOGENIC TEMPERATURES, filed Jul. 14, 2014, the disclosure of which is incorporated by reference herein in its entirety.

### BACKGROUND OF THE DISCLOSURE

1.0 Field of the Disclosure

The present disclosure relates to a method for, inter alia, cold cleaving sapphire and, more particularly, a method for cold cleaving sapphire at cryogenic temperatures.

2.0 Related Art

Cleaving processes are well understood and commonly performed on single crystal wafers or other single crystal material. However, these current techniques are relatively incompatible with sapphire, due to its poor cleavability. For example, sapphire does not exhibit the strong cleavability of materials such as, e.g., silicon.

Current processes for cutting sapphire are laborious and expensive because sapphire does not exhibit strong cleavability or otherwise splitting along a specific plane. Cleaving or cutting sapphire at room temperatures results in poor yields due to the tendency of the wafer to break along directions other than the intended direction and often leads to material cracking. This results in a significant waste of sapphire material. Waste of material increases costs of production.

Therefore, a technique for cleaving, cutting or otherwise dividing a sapphire crystal along a crystal plane that is quicker and more economical than current techniques would be advantageous.

### SUMMARY OF THE DISCLOSURE

According to one non-limiting aspect of the disclosure, a method is provided to divide single-crystal material such as sapphire cooled to a cryogenic temperature to provide a more economical and efficient process.

In one aspect, a method for dividing a single-crystal material includes the steps of cooling the single-crystal material to a cryogenic temperature and cleaving the single-crystal material to produce at least one sharp-edged portion. The single-crystal material may be sapphire. The cryogenic temperature may be less than −150° C. Moreover, the cryogenic temperature may be less than about −196° C. The cleaving step may comprise cleaving along a plane of the single-crystal material. The cleaving step may cleave using a cleaving tool. The cleaving step may cleave using a laser. The method may further comprise aligning the single-crystal material with respect to a cleaving tool. The aligning may align a plane of the single-crystal material with respect to the cleaving tool. The cooling step may be computer controlled. The method may further comprise determining a plane within the single-crystal material for cleaving along the determined plane. The determining step may be performed prior to the cooling step.

In one aspect, a system for dividing a single-crystal material is provided. The system includes a mechanism for cooling a single crystal material to a cryogenic temperature and a tool to cleave the cooled single crystal material to produce at least one sharp-edged portion. The mechanism for cooling comprises a device to contain a coolant for submerging the single crystal material in the coolant. The coolant may be liquid nitrogen. The system may further comprise a goniometer to determine a plane within the single crystal material for cleaving along the determined plane. The cleaving tool may comprise one of: a laser and a heated cleaving tool. The system may further comprise a robotic mechanism to submerge the single crystal material in a cryogenic coolant. The single crystal material comprises sapphire. The system may further comprise a computer to control at least one of: the mechanism for cooling, the tool to cleave and the goniometer.

Additional features, advantages, and embodiments of the disclosure may be set forth or apparent from consideration of the detailed description, drawings and attachment. Moreover, it is to be understood that the foregoing summary of the disclosure and the following detailed description, and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is an example flow diagram showing a process for dividing sapphire, the steps of the process performed according to principles of the disclosure;

FIG. 2A is an example of cooling a single crystal material to a cryogenic temperature, configured according to principles of the disclosure;

FIG. 2B is an example of a x-ray goniometer for determining one or more planes in a single crystal material, configured according to principles of the disclosure;

FIG. 2C is an example of a cleaving tool, configured according to principles of the disclosure;

FIG. 2D is an example of a laser for cleaving a single crystal material, configured according to principles of the disclosure;

FIG. 2E is an example of a system for cleaving or cutting a single crystal material at a cryogenic temperature, configured according to principles of the disclosure;

FIG. 2E is an example block diagram of various components for cleaving sapphire, configured according to principles of the disclosure.

FIG. 3 is an example of a sapphire wafer showing various planes and a wafer flat, configured according to principles of the disclosure; and

FIG. 4 is an illustration of a device employing sapphire as cut or cleaved from sapphire material or a sapphire wafer by the process of FIG. 1 and/or the system of FIG. 2E.

### DETAILED DESCRIPTION OF THE DISCLOSURE

The disclosure and the various features and advantageous details thereof are explained more fully with reference to the non-limiting examples that are described and/or illustrated in the accompanying drawings and detailed in the following description. It should be noted that the features illustrated in the drawing are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the examples of the disclosure. Accordingly, the examples herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise. The term “about” herein means within 10% of the specified amount or number unless context states otherwise.

The terms “a”, “an”, and “the”, as used in this disclosure, means “one or more”, unless expressly specified otherwise. The term “about” used herein means within +/−10%, unless context states otherwise. The term “cryogenic” herein means below minus 150° C.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

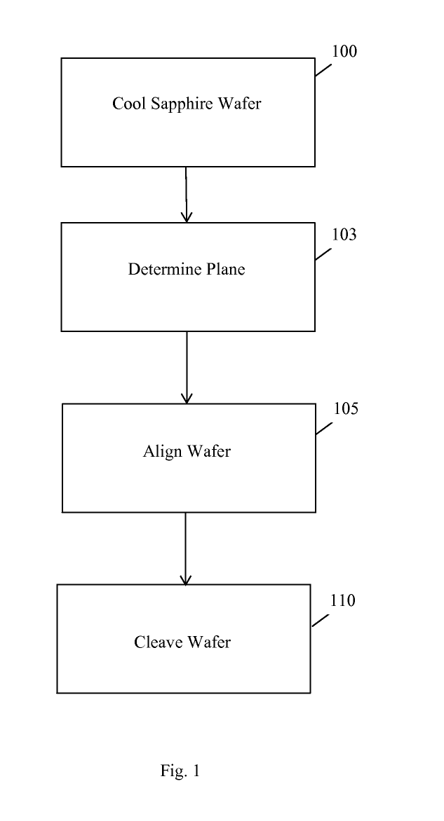

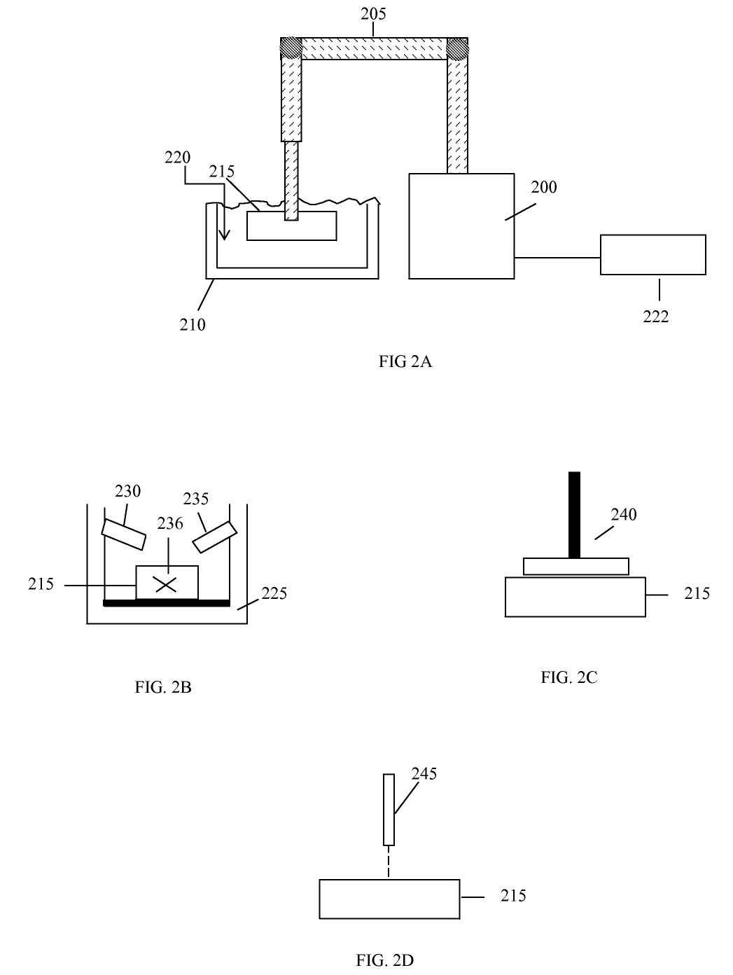

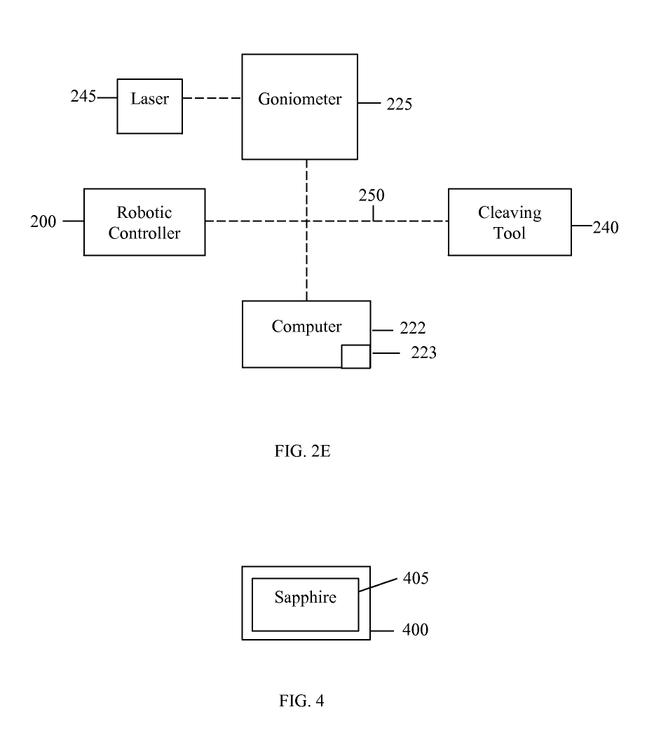

The disclosure is generally directed to a process for dividing a single-crystal wafer or sheet, such as sapphire. FIG. 1 shows an example flow diagram showing a process for dividing sapphire 215, the steps of the process performed according to principles of the disclosure. At step 100, the sapphire 215 may comprise a sapphire wafer, e.g., wafer 300 (FIG. 3), or sapphire sheet may be cooled to a cryogenic temperature. The preferred cryogenic temperature is about the boiling point of nitrogen, i.e., about −196° C. (about 77° K), although the temperature may be significantly less than this. Moreover, other liquids or techniques might be used to achieve a suitable cryogenic temperature. For example, the sapphire wafer or sheet that is to be divided may be immersed in a bath 210 (FIG. 2A) filled with coolant 220 such as, e.g., liquid nitrogen for a period of time to assure that the sapphire wafer or sheet has achieved a desired uniform cryogenic temperature. The time might vary depending on the size of the sapphire wafer sheet and the specific mode of cooling being used. In one aspect, the cooling might be facilitated by a robotic mechanism such as a robotic arm 205 to hold the sapphire while being immersed, and subsequently to move to a next step. The robotic arm 205 may be connected to a controller 200 which may in turn be connected by a communication link 250 (FIG. 2E) to a computer 222 that is configured to coordinate one or more of the various operations for cleaving a sapphire wafer or sheet. At step 103, one or more planes 236 of the crystal structure, e.g., a-plane, c-plane or r-plane, may be determined such as by use of, e.g., an x-ray goniometer 225 (FIG. 2B). As a sub-step, a wafer flat 305 (FIG. 3) may be created to indicate orientation of the sapphire 215 or sapphire wafer 300 with respect to a desired plane.

Once the sapphire 215 has been cooled to the desired cryogenic temperature, at step 105, the sapphire sheet or wafer may be aligned or oriented in a particular manner in preparation for the cleaving step 110. The orientation may be based on a plane within the sapphire sheet, as previously determined. The orientation or alignment might be based on the desired direction along the width or length of the sapphire wafer or sheet. The alignment may also account for an intended desired resulting width in the divided portions. Moreover, the alignment might also be made so that the wafer or sheet is aligned in relation to the particular cleaving tool 240 (FIG. 2C) being employed for the cleaving. The alignment of the tool may include aligning the tool along one or the desired planes of the sapphire 215, such as determined by the x-ray goniometer 225. A cleaving tool 240 might comprise, e.g., a point punch, a diamond tip, a carbide tip, a razor blade type edge, or the like. Moreover, the cleaving tool 240 might comprise a heated cleaving tool to impart a temperature shock. In some embodiments, the cleaving tool 245 may comprise a laser.

At step 110, the sapphire wafer, e.g., wafer 300, or sheet may be divided by impacting the sapphire wafer or sheet with the cleaving tool 240. In some embodiments, the cleaving step may be accomplished by using a laser 245 (FIG. 2D) to initiate cleaving along a plane of the sapphire 215.

At cryogenic temperatures, the sapphire 215 becomes more brittle and exhibits a tendency to divide cleanly and precisely along a crystal plane when cleaved. Without cooling the sapphire to a cryogenic temperature, the sapphire wafer or sheet would have poor cleavability. Cleaving after the sapphire material has been cooled to cryogenic temperatures, produces a resulting edge of the divided portions that can be highly useful and desirable for creating products that require an atomically sharp edge, such as, e.g., razor blades. Moreover the process described herein may be used to produce other sapphire based products, such as sapphire LEDs.

The process of FIG. 1 may be repeated as necessary to achieve a particular number and/or particular size of sapphire cleaved material. For example, repeatedly cutting or dividing previously divided portions may result in sapphire made to a particular size and/or width. The process of FIG. 1 may be facilitated by a robotic mechanism 200, e.g., that may be computer controlled 222 for managing and carrying out the steps of the process.

FIG. 2A is an example block diagram of a cooling bath and associated controllers, configured according to principles of the disclosure. A coolant bath 210, which may be filled with a coolant 220 such as liquid nitrogen, may be used to cool the sapphire 215 to a cryogenic temperature. The sapphire 215 may be held in the coolant 220 by a robotic arm 205 or other mechanism. A robotic controller 200 may control the robotic arm 205 and may be in communication with computer 222 via communications link 250.

FIG. 2B is an example illustration of an x-ray goniometer 225 for use in determining crystal plane orientation and/or one or more or axis 236 of the sapphire 215. The x-ray goniometer 225 may include an x-ray emitter 230 and an x-ray detector 235.

FIG. 2C is an example of a cleaving tool 240 for cleaving sapphire 215 after the sapphire has been cooled to a cryogenic temperature. The cleaving tool 240 may comprise, e.g., a point punch, a diamond tip, a carbide tip, a razor blade type edge, or the like.

FIG. 2D is an example of a laser 245 that may be employed to cleave the sapphire 215. The laser 245 may be under computer 222 control. The energy of the laser is capable of causing cleavage of the cooled sapphire 215 along a predetermined plane.

FIG. 2E is an example block diagram of various components for cleaving sapphire, configured according to principles of the disclosure. A computer 222 may be in communication over a communication link 250 with one or more components, as described above, for controlling the process of cleaving sapphire. The computer 222 may be connected to one or more of (or a plurality of, or all of) the robotic controller 200, the goniometer 225, the cleaving tool 240 and the laser 245. The computer 222 may control the various operations of the cooling, the transfer of the sapphire from one stage to the next, the determination of one or more planes of the sapphire 215 using the goniometer 225, controlling orientation of the sapphire 215 for cleaving and/or the orientation of the cleaving tool 240, controlling the operation and targeting of the laser 245 for cleaving the sapphire 215 along a desired plane. The computer 222 may be a single computer or a plurality of separate computers. The computer 222 may be connected to a database (not shown) for accessing production parameters and software and for storing production results. The computer 222 may be operably coupled to a computer readable medium 223 which may store software and parameters for performing the various steps herein.

FIG. 3 is an example of a sapphire wafer 300 showing various planes and a wafer flat, configured according to principles of the disclosure. The exemplary c-plane sapphire wafer 300 may include a and m orientations (6 of each) within the plane; for simplicity, FIG. 3 shows only one of each, m-orientation 310 and a-orientation 315. A wafer flat 305 is shown indicating the orientation of the wafer. The wafer flat may be used to align the wafer 300 with a cleaving tool 240 or laser 245 or, conversely, to align the cleaving tool 240 or laser 245 with the wafer 300.

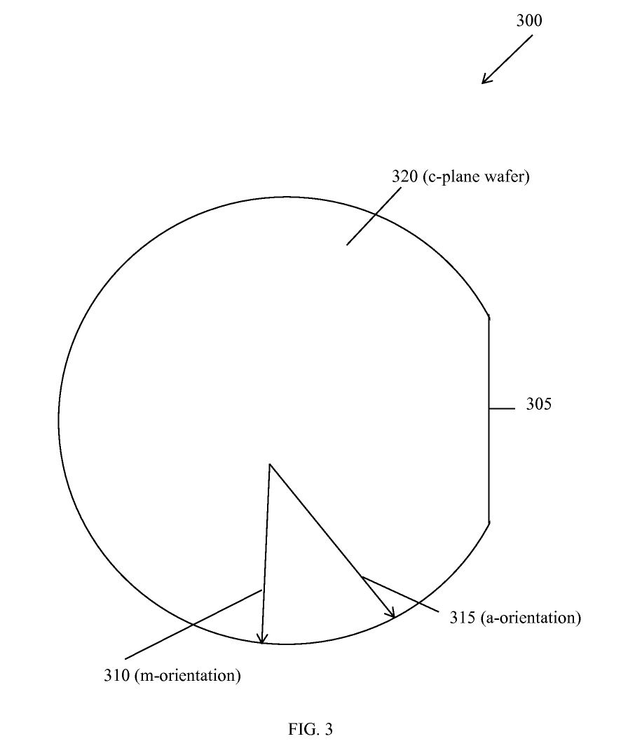

FIG. 4 is an illustration of a device 400 employing sapphire 405 as cut or cleaved from the sapphire 215 or wafer 300 by the process of FIG. 1 and/or the system of FIG. 2E. The device 400 may be a product that may include, but not limited to, e.g., an electrical device, an optical device, a timepiece, an industrial device, a cutting device, a consumer product, or the like. The sapphire 405 may be configured or positioned as required for use with or in the device 400.

The process of dividing a sapphire wafer or sheet described herein has several advantages over current traditional techniques. For example, the sapphire waste may be substantially reduced, and the cleaving or dividing may be far quicker and economical than current traditional techniques. Moreover, the process may be highly selective in the direction the sapphire material is divided. The process herein tends to avoid cracking or unintended splitting of the sapphire in an unintended manner. Moreover, the process herein may be applied to any single crystal material, wafer or sheet that normally cannot be easily cleaved at room temperature.

Robotic techniques may be employed to perform the various tasks of the process described herein such as, e.g., cooling the single-crystal material, cleaving the single-crystal material, aligning the single-crystal material for cleaving, controlling a laser if cleaving employs a laser, controlling a cleaving tool, locating and/or aligning a plane of the single-crystal material for cleaving, moving the single-crystal material as required during processing, or the like. The robotic techniques may be computer controlled with software controlling the various steps of the process.

FIG. 1 may also represent a block diagram of the components for performing the respective steps. For example, the steps of FIG. 1 may also represent software configured to be executed by a computer, e.g., computer 222, that when read from a non-transitory storage medium 223 and executed by the computer performs the respective steps. Moreover, the components of FIG. 1 may be embodied on a non-transitory computer readable medium which may comprise a computer-program product.

While the disclosure has been described in terms of examples, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A method for dividing a single-crystal material, the method comprising the steps of:
cooling the single-crystal material to a cryogenic temperature; and
cleaving the single-crystal material to produce at least one sharp-edged portion.

2. The method of claim 1, wherein the cryogenic temperature is less than −150° C.

3. The method of claim 1, wherein the cryogenic temperature is about −196° C.

4. The method of claim 1, wherein the cleaving step comprises cleaving along a plane of the single-crystal material.

5. The method of claim 1, wherein the single-crystal material is sapphire.

6. The method of claim 1, wherein the cleaving step cleaves using a laser.

7. The method of claim 1, wherein the cleaving step cleaves using a cleaving tool.

8. The method of claim 1, further comprising aligning the single-crystal material with respect to a cleaving tool.

9. The method of claim 8, wherein the aligning aligns a plane of the single-crystal material with respect to the cleaving tool.

10. The method of claim 1, wherein the cooling step is computer controlled.

11. The method of claim 1, further comprising determining a plane within the single-crystal material for cleaving along the determined plane.

12. The method of claim 11, wherein the determining step is performed prior to the cooling step.

13. A device embodying the single-crystal material produced by the process of claim 1.

14. A system for dividing a single-crystal material, comprising:
a mechanism for cooling a single crystal material to a cryogenic temperature;
a tool to cleave the cooled single crystal material to produce at least one sharp-edged portion.

15. The system of claim 14, wherein the mechanism for cooling comprises a device to contain a coolant for submerging the single crystal material in the coolant.

16. The system of claim 14, wherein the coolant is liquid nitrogen.

17. The system of claim 14, further comprising a goniometer to determine a plane within the single crystal material for cleaving along the determined plane.

18. The system of claim 14, wherein the cleaving tool comprises one of: a laser and a heated cleaving tool.

19. The system of claim 14, further comprising a robotic mechanism to submerge the single crystal material in a cryogenic coolant.

20. The system of claim 14, wherein the single crystal material comprises sapphire.

21. The system of claim 14, further comprising a computer to control at least one of: the mechanism for cooling, the tool to cleave and a goniometer.
